(19) United States
(12) Patent Application Publication
(10) Pub. No.: US 2026/0086190 A1
(43) Pub. Date: Mar. 26, 2026

(54) METHODS AND SYSTEMS FOR HYBRID INDOOR POSITIONING

(71) Applicant: Alps Alpine Co., Ltd., Tokyo (JP)

(72) Inventors: Mingda ZHOU, Auburn Hills, MI (US); Zachary DENNY, South Lyon, MI (US); Stone MAGUIRE, Clarkston, MI (US); Jacob ALAM, Chesterfield Township, MI (US); Chengchun FANG, Rochester Hills, MI (US)

(21) Appl. No.: 18/893,633

(22) Filed: Sep. 23, 2024

(51) Int. Cl. G01S 5/02

(52) U.S. Cl. CPC G01S 5/0268; G01S 5/02955; G01S 2205/02

(57) ABSTRACT

A method for determining a position of an object includes determining a first estimated location of the object based on a distance matrix, a range matrix, and a weight matrix, updating the weight matrix based on distance related factors and ranging technique related factors, and determining a second estimated location based on the distance matrix, the range matrix, and the updated weight matrix. The distance matrix includes distances between the object and one or more anchors and the range matrix includes ranging measurements for ranging communications between the object and the one or more anchors.

### FIELD

The present disclosure relates to systems and methods for hybrid indoor positioning.

### BACKGROUND

This section provides background information related to the present disclosure which is not necessarily prior art.

Indoor areas that require positioning of an object may include a system hub and one or more anchors used to determine a position of that object. The indoor area may include multiple sub-areas that may require different positioning accuracies. Different ranging techniques may be employed throughout the indoor area between one or more of the system hub, the anchors, or the object.

### BRIEF SUMMARY

This section provides a general summary of the disclosure and is not a comprehensive disclosure of its full scope or all of its features.

At least one example embodiment is a method for determining a position of an object. The method may include determining a first estimated location of a tag coupled to the object based on a distance matrix, a range matrix, and a weight matrix, updating the weight matrix based on distance related factors and ranging technique related factors, and determining a second estimated location of the tag based on the distance matrix, the range matrix, and the updated weight matrix. The distance matrix may include distances between the tag and one or more anchors and the range matrix may include ranging measurements for ranging communications between the tag and the one or more anchors.

In at least one example embodiment, the ranging measurements for the ranging communications may include a ranging measurement for each ranging technique of each anchor based on a distance between the tag and the anchor and a corresponding ranging residual.

In at least one example embodiment, the method may further include updating the first estimated location before updating the weight matrix if a position residual is greater than a first threshold.

In at least one example embodiment, the method may further include outputting the second estimated location as the position of the object. In at least one example embodiment, the method may further include updating the second estimated location before outputting the second estimated location as the position of the object if a position residual is greater than a second threshold.

In at least one example embodiment, determining the distance related factors may include, for each ranging technique for each anchor of the one or more anchors, dividing a minimum of a norm of the distance matrix minus the range matrix by an absolute value of a distance between the tag and the anchor minus a ranging measurement for the ranging communications between the tag and the anchor. In at least one example embodiment, the method may further include comparing a distance related factor for each anchor and each ranging technique to a distance related factor threshold and removing the distance between the tag and the anchor and the ranging measurement for the ranging communications between the tag and the anchor from the distance between the tag and the one or more anchors and the ranging measurements for the ranging communications between the tag and the one or more anchors.

In at least one example embodiment, determining the ranging technique related factors may include, for each ranging technique for each anchor of the one or more anchors, obtaining a first ranging technique related factor from a table of factors and determining a ranging technique related factor as a normalized value based on the first ranging technique related factor and a plurality of further ranging technique related factors in the table of factors. In at least one example embodiment, determining the ranging technique related factor as a normalized value may include dividing the first ranging technique related factor by a sum of the first ranging technique related factor and the plurality of further ranging technique related factors.

In at least one example embodiment, the weight matrix may be a diagonal matrix based on an accuracy requirement for the position of the object and an entry of the weight matrix for an anchor and a ranging technique may be determined by multiplying a corresponding distance related factor by a corresponding ranging technique related factor.

Also described herein is a system for determining a position of an object. The system may include at least one memory configured to store instructions and at least one processor configured to execute the instructions to cause the system to perform determining a first estimated location of a tag coupled to the object based on a distance matrix, a range matrix, and a weight matrix, updating the weight matrix based on distance related factors and ranging technique related factors, and determining a second estimated location of the tag based on the distance matrix, the range matrix, and the updated weight matrix. The distance matrix may include distances between the tag and one or more anchors and the range matrix may include ranging measurements for ranging communications between the tag and the one or more anchors.

In at least one example embodiment, the ranging measurements for the ranging communications may include a ranging measurement for each ranging technique of each anchor based on a distance between the tag and the anchor and a corresponding ranging residual.

In at least one example embodiment, the at least one processor may be further configured to execute the instructions to cause the system to perform updating the first estimated location before updating the weight matrix if a position residual is greater than a first threshold.

In at least one example embodiment, the at least one processor may be further configured to execute the instructions to cause the system to perform outputting the second estimated location as the position of the object. In at least one example embodiment, the method may further include updating the second estimated location before outputting the second estimated location as the position of the object if a position residual is greater than a second threshold.

In at least one example embodiment, determining the distance related factors may include, for each ranging technique for each anchor of the one or more anchors, dividing a minimum of a norm of the distance matrix minus the range matrix by an absolute value of a distance between the tag and the anchor minus a ranging measurement for the ranging communications between the tag and the anchor. In at least one example embodiment, the at least one processor may be further configured to execute the instructions to cause the system to perform comparing a distance related factor for each anchor and each ranging technique to a distance related factor threshold and removing the distance between the tag and the anchor and the ranging measurement for the ranging communications between the tag and the anchor from the distance between the tag and the one or more anchors and the ranging measurements for the ranging communications between the tag and the one or more anchors.

In at least one example embodiment, determining the ranging technique related factors may include, for each ranging technique for each anchor of the one or more anchors, obtaining a first ranging technique related factor from a table of factors and determining a ranging technique related factor as a normalized value based on the first ranging technique related factor and a plurality of further ranging technique related factors in the table of factors. In at least one example embodiment, determining the ranging technique related factor as a normalized value may include dividing the first ranging technique related factor by a sum of the first ranging technique related factor and the plurality of further ranging technique related factors.

In at least one example embodiment, the weight matrix may be a diagonal matrix based on an accuracy requirement for the position of the object and an entry of the weight matrix for an anchor and a ranging technique may be determined by multiplying a corresponding distance related factor by a corresponding ranging technique related factor.

### BRIEF DESCRIPTION OF THE SEVERAL VIEWS OF THE DRAWINGS

The drawings described herein are for illustrative purposes only of selected embodiments and not all possible implementations and are not intended to limit the scope of the present disclosure.

FIG. 1 is an indoor system for indoor positioning according to an example embodiment.

FIG. 2 is an illustration of communications between an object and an anchor of an indoor system for indoor positioning according to an example embodiment.

FIG. 3 is a flow chart of a method for determining a position of an object according to an example embodiment.

FIG. 4 is a block diagram of a system suitable for implementing the methods described herein according to an example embodiment.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a personal area network (PAN), a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (I) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments will now be described more fully with reference to the accompanying drawings.

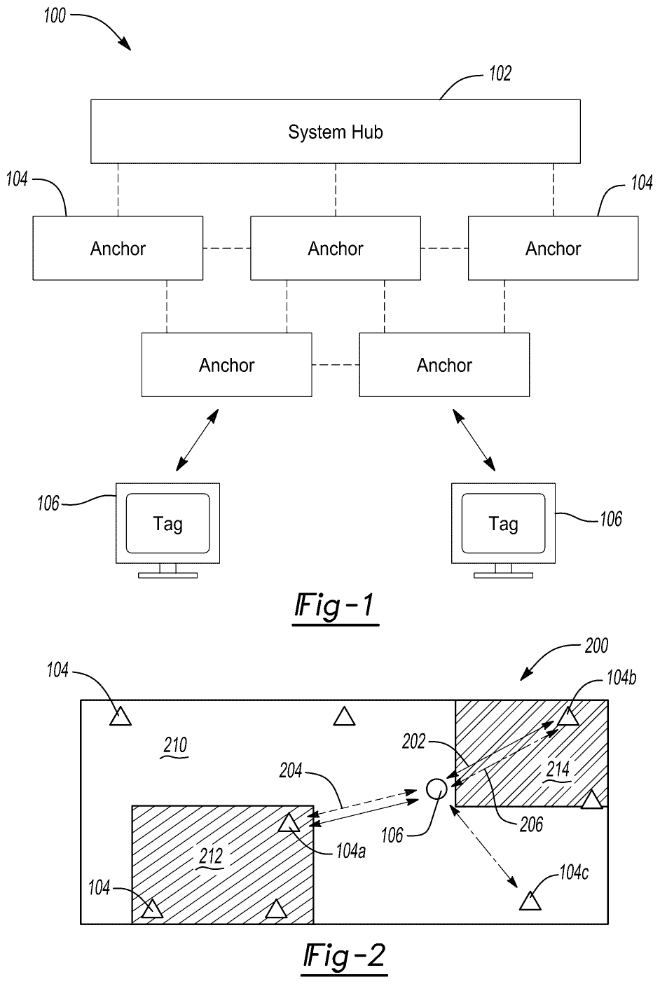

FIG. 1 is a system 100 for hybrid positioning according to an example embodiment. While the system 100 for hybrid positioning is described herein with respect to an indoor area, the system 100 may also be deployed in an outdoor space in at least one example embodiment. The system 100 may include a system hub 102. The system hub 102 may be a central hub for the system 100 and may include one or more processors and/or memories that may be configured to perform or provide information for the indoor positioning described herein.

The system 100 may also include one or more anchors 104. The one or more anchors 104 may be deployed at various locations throughout an indoor area. In at least one example embodiment, the one or more anchors 104 may be stationary and their locations may be known to the system hub 102. In at least one example embodiment, the one or more anchors 104 may be dispersed about an entirety of the indoor area. Each of the one or more anchors 104 may be connected to and/or in communication with one or more of the one or more anchors 104 and/or the system hub 102. In at least one example embodiment, each of the one or more anchors 104 and the system hub 102 may be connected via a mesh network. In at least one example embodiment, the mesh network may be a Thread network or a Zigbee network although example embodiments are not limited herein. In at least one example embodiment, the one or more anchors 104 may each be a system-on-a-chip (“SOC”) that may be configured to communicate with the system hub 102. For example, the one or more anchors 104 may be an nRF5340 SOC from Nordic® Semiconductor.

The system 100 may also include a tag 106. The tag 106 may be placed on an object within the indoor area to track a position of the object. In at least one example embodiment, there may be multiple tags that may be used to track multiple objects. The object that the tag 106 is attached to may be either mobile or stationary within the indoor area. The tag 106 may be configured to communicate with one or more of the one or more anchors 104 or the system hub 102 in at least one example embodiment. In at least one example embodiment, the tag 106 may communicate with the one or more anchors 104 or the system hub 102 via one or more wireless communication protocols. The wireless communication protocols may include, without limitation, Bluetooth, ultra-wideband (UWB), and/or Wi-Fi. The tag 106 must be attached to the object in order to determine a location of the object. As described herein, a location of an object and a location of the tag 106 are the same. Thus, determining a location and/or position of an object also describes determining a location and/or position of the tag 106. In at least one example embodiment, the tag 106 may be an SOC that may be configured to communicate with the one or more anchors 104 and/or the system hub 102. For example, tag 106 may be an nRF5340 SOC from Nordic® Semiconductor.

In at least one example embodiment, data communications within the system 100 may be isolated from ranging communications. Ranging communications may be communications between the tag 106 and the one or more anchors 104 and/or the system hub 102 and data communications may be communications between the one or more anchors 104 and/or the system hub 102. As described above, communications between the tag 106 and the one or more anchors 104 and/or the system hub 102 preferably utilize wireless communication protocols while communications between the one or more anchors 104 and/or the system hub 102 preferably utilize mesh networks. Thus, data communications and ranging communications may be well isolated which may minimize traffic congestion and may reduce delay in the system 100.

FIG. 2 is an example embodiment of an indoor area 200 that may include one or more components of the system 100 with the one or more anchors 104 and the tag 106. The tag 106 is in communication with a first anchor 104a via a first ranging technique 202 and a second ranging technique 204. The tag 106 is in communication with a second anchor 104b via the first ranging technique 202 and a third ranging technique 206. The tag 106 is also in communication with a third anchor 104c via the third ranging technique 206. In at least one example embodiment, the first ranging technique 202, the second ranging technique 204, and the third ranging technique 206 may be any of the wireless communication protocols described above. The different communication techniques are consistently illustrated in FIG. 2 with double headed arrows having different line types, such as solid, dashed, and dot-dashed.

The indoor area 200 may include a first area 210, a second area 212, and a third area 214. The first area 210, the second area 212, and the third area 214 may require different positioning accuracies. For example, the second area 212 of the indoor area 200 may be a geofenced area such as a server room, for example, and may require a greater positioning accuracy than a location within the first area 210. Thus, it may be acceptable for an uncertainty or error of a determined location of an object in the second area to be less than an uncertainty or error of a determined location of the object outside of the second area.

When determining a position of the tag 106, a distance between the tag 106 and one of the one or more anchors 104 is determined. Then, the distance is used to determine a range measurement. In at least one example embodiment, a location of the tag 106 may include an x, y, and z coordinate such that the location is (x, y, z). Similarly, a location of one of the one or more anchors 104 may be given by (xᵢ, yᵢ, zᵢ). For example, a location of the first anchor 104a may be (x₁, y₁, z₁), a location of the second anchor 104b may be (x₂, y₂, z₂), and a location of the third anchor 104c may be (x₃, y₃, z₃).

A distance between the tag 106 and an anchor of the one or more anchors 104 may be given by the equation dᵢ=\sqrt{(x−xᵢ)²+(y−yᵢ)²+(z−zᵢ)²}. Then, a corresponding range measurement is given by the equation rᵢ=dᵢ+wᵢ where wᵢ is a ranging residual. Then, when there is only one ranging measurement per anchor, a distance matrix may be defined by

$$f ( x ) = [ \begin{matrix}\sqrt{{( x - {x}_{i} )}^{2} + {( y - {y}_{i} )}^{2} + {( z - {z}_{i} )}^{2}} \\ ⋯ \\ \sqrt{{( x - {x}_{m} )}^{2} + {( y - {y}_{m} )}^{2} + {( z - {z}_{m} )}^{2}}\end{matrix} ]$$

where x=(x, y, z) and a range matrix may be defined as r=[r₁, . . . rₘ] T, thus, the range matrix includes ranging measurements for ranging communications between the tag 106 and the one or more anchors 104.

When determining the position of the tag 106 with only one ranging technique between the tag 106 and an anchor, the goal is to obtain min (∥f(x)−r∥²). In particular,

$${‖ f ( x ) - d ‖}^{2} = {\sum }_{i = 1}^{m} {w}_{i}^{2} .$$

Thus, the goal is to minimize the sum of squares of range measurement residuals. The Gauss-Newton method, as known in the art, may be used to minimize the sum of squares of range measurement residuals. A Jacobian matrix to be used in the Gauss-Newton method for f (x) may be defined as

$$J ( x ) = [ \begin{matrix}\frac{x - {x}_{1}}{{r}_{1}} & \frac{y - {y}_{1}}{{r}_{1}} & \frac{z - {z}_{1}}{{r}_{1}} \\ ⋯ & ⋯ & ⋯ \\ \frac{x - {x}_{m}}{{r}_{m}} & \frac{y - {y}_{m}}{{r}_{m}} & \frac{z - {z}_{m}}{{r}_{m}}\end{matrix} ] .$$

The matrices described above for f (x) and r are for a situation where there is only one ranging technique between the tag 106 and each of the one or more anchors 104. When there are multiple ranging techniques between the tag 106 and an anchor, there may be multiple range measurements for that tag/anchor pair. In particular, if there are two ranging techniques between the tag 106 and a first anchor of the one or more anchors 104, then the two range measurements for the tag 106 and first anchor pair are given by:

$${r}_{1}^{1} = {d}_{1} + {w}_{1}^{1} and {r}_{1}^{2} = {d}_{1} + {w}_{1}^{2}$$

where the distance is calculated as described above. Similarly, for the tag 106 and a second anchor with two ranging techniques between them, ranging measurements may be given by:

$${r}_{2}^{1} = {d}_{2} + {w}_{2}^{1} and {r}_{2}^{2} = {d}_{2} + {w}_{2}^{2} .$$

When there are multiple ranging techniques employed between the tag 106 and an anchor of the one or more anchors 104, there may be different accuracy requirements and a weight matrix may be employed to achieve a desired adaptive high accuracy. For example, each ranging technique may have its own ranging accuracy or accuracy requirement. In at least one example embodiment, the weight matrix may be a diagonal matrix defined by

$$α = diag ( [ {α}_{1}^{1} , … , {a}_{1}^{{n}_{1}} , … , {α}_{m}^{1} , … , {a}_{m}^{{n}_{m}} ] ) .$$

The weight matrix is then used to determine a position of the tag 106 by obtaining min {(f(x)−r)^{T}α(f(x)−r)} where

$${r}_{i} = {[ {r}_{1}^{1} , … {r}_{i}^{{n}_{i}} ]}^{T} and r = {[ {r}_{1}^{T} , … {r}_{m}^{T} ]}^{T} .$$

The weight matrix may be used to ensure that the different ranging techniques are afforded different weights. For example, a first ranging technique that is more accurate than a second ranging technique may be weighted greater than the second ranging technique such that the first ranging technique contributes more in the positioning calculation than the second ranging technique. Similar to the single ranging technique calculations described above, the Gauss Newton method, as known in the art, may be used to minimize {(f(x)−r)^{T}α(f(x)−r)}. A Jacobian matrix to be used in the Gauss Newton method may be defined to isolate the weight matrix such that:

$${J}_{i} ( x ) = [ \begin{matrix}\frac{x - {x}_{1}}{{r}_{1}^{1}} & \frac{y - {y}_{1}}{{r}_{1}^{1}} & \frac{z - {z}_{1}}{{r}_{1}^{1}} \\ ⋯ & ⋯ & ⋯ \\ \frac{x - {x}_{1}}{{r}_{1}^{{n}_{1}}} & \frac{y - {y}_{1}}{{r}_{1}^{{n}_{1}}} & \frac{z - {z}_{1}}{{r}_{1}^{{n}_{1}}}\end{matrix} ] and J ( x ) = {α}^{1 / 2} [ \begin{matrix}{J}_{1} ( x ) \\ ⋯ \\ {J}_{m} ( x )\end{matrix} ] .$$

The Jacobian matrix may be used to perform trilateralization to determine a position of the tag 106. The application of the Jacobian matrix towards the Gauss-Newton method is as follows: xₜ₊₁=xₜ−β(J(x)^{T}J(x)⁻¹J(x)^{T}[f(x)−r] where t=0, 1, 2 . . . is step t and β is the learning rate (generally 0.05˜0.5).

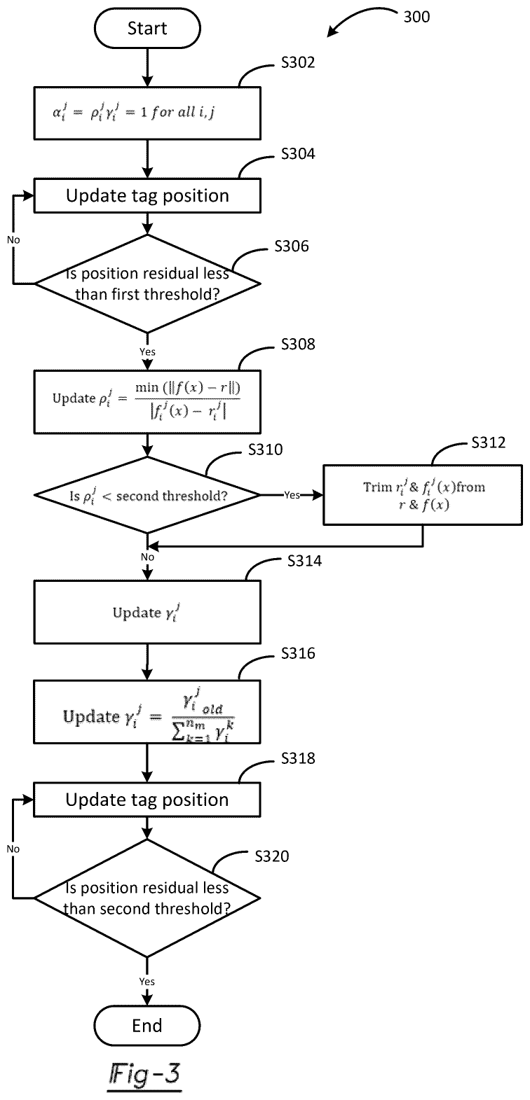

FIG. 3 is a flow chart of a method 300 of determining a position of a tag in an indoor space. The method 300 is described below with reference to the tag 106 described above. The method 300 may be used to determine the weight matrix, a, that is used to determine the position of the tag in the indoor space.

At step S302 each element of the weight matrix, a, may be defined as

$${α}_{i}^{j} = {ρ}_{i}^{j} {γ}_{i}^{j} = 1$$

for all i, j where ρ is a distance related factor and γ is a ranging technique related factor. Thus, the same weight is assigned to each range measurement at a first step of the method 300. The weight matrix defines an element of the weight matrix for each ranging technique for each anchor of the indoor system.

As the method 300 progresses, a position of the tag is updated by the weight matrix, a, being updated based on updated values for the distance related factor, p, and the ranging technique related factor, y. In particular, the Gauss-Newton method as described above is used until a position residual for the tag 106 is less than a threshold. The position residual is an uncertainty or error of the position of the tag 106. This may indicate that the position of the tag 106 is in a range of a desired accuracy such that the determined position may be output as the position of the tag 106. In at least one example embodiment, the position residual is determined based on the ranging residual and the Jacobian matrix such that the position residual is defined by (J(x)^{T}J(x))⁻¹J(x)^{T}[f(x)−r].

At step S304, a position of the tag 106 is determined and/or updated. For example, in a first iteration, the position of the tag 106 is determined and in an iteration subsequent to the first iteration, the position of the tag 106 is updated. As described above, the position of the tag 106 may be determined by obtaining min {(f(x)−r)^{T}α(f(x)−r)}. By determining and/or updating a position of the tag 106, a first estimated location of the object is determined.

At conditional step S306, the position residual of the position of the tag 106 is compared to a first threshold value. In at least one example embodiment, the first threshold value may be defined or predefined for the particular indoor space. In particular, empirical evidence may be used to determine the first threshold value. For example, in an office environment, the first threshold value of 0.5 m may be used. However, the first threshold value may be larger or smaller. For example, the first threshold value may be 0.01 m in at least one example embodiment.

If the position residual is not less than the first threshold value, then then the position of the tag 106 is further updated at step S304. The step S304 and S306 may be repeated until the position residual is less than the first threshold value.

If the position residual is less than the first threshold value, then at step S308 the distance related factor, ρ, is updated. In particular, the distance related factor, ρ, is updated by:

$${ρ}_{i}^{j} = \frac{min ( ‖ f ( x ) - r ‖ )}{\vert {f}_{i}^{j} ( x ) - {r}_{i}^{j} \vert} .$$

At conditional step S310,

$${ρ}_{i}^{j}$$

is compared to a second threshold. In at least one example embodiment, the second threshold may be a distance related factor threshold. If

$${ρ}_{i}^{j}$$

is less than the second threshold, at step S312

$${r}_{i}^{j} and {f}_{i}^{j} ( x )$$

are trimmed from f(x) and r. In particular,

$${r}_{i}^{j} and {f}_{i}^{j} ( x )$$

are excluded from f(x) and r. In at least one example embodiment,

$${r}_{i}^{j} and {f}_{i}^{j} ( x )$$

may be excluded because inclusion of

$${r}_{i}^{j} and {f}_{i}^{j} ( x )$$

leads to too large of an error value for f(x) and r. After

$${r}_{i}^{j} and {f}_{i}^{j} ( x )$$

are trimmed for f(x) and r, the method 300 proceeds to step S314. Also, if

$${ρ}_{i}^{j}$$

is not less than the second threshold, then the method 300 proceeds to step S314.

At step S314, the ranging technique related factor, γ, is updated. In particular,

$${γ}_{i}^{j}$$

may be updated based on a particular ranging technique and/or

$${f}_{i}^{j} ( x ) .$$

For example, tor an UWB ranging technique

$${γ}_{i}^{j}$$

may be set to: 5 for

$${f}_{i}^{j} ( x ) \leq 5 m ,$$

3 for

$$5 m \leq {f}_{i}^{j} ( x ) \leq 15 m ;$$

and 0 for

$${f}_{i}^{j} ( x ) > 5 m .$$

For a Bluetooth ranging technique that is flight time based,

$${γ}_{i}^{j}$$

may be set to: 3 for

$${f}_{i}^{j} ( x ) \leq 5 m ,$$

2 for

$$5 m < {f}_{i}^{j} ( x ) \leq 15 m ;$$

and 2 for

$${f}_{i}^{j} ( x ) > 5 m .$$

For a Bluetooth ranging technique that is received signal strength indicator (“RSSI”) based

$${y}_{i}^{j}$$

may be set to: 2 for

$${f}_{i}^{j} ( x ) \leq 5 m ,$$

0.5 for

$$5 m < {f}_{i}^{j} \leq 15 m ;$$

and 0.3 for

$${f}_{i}^{j} ( x ) > 5 m .$$

However, the values for

$${y}_{i}^{j}$$

are determined from empirical evidence and are not limited to the values described herein. Further, additional ranging techniques may be employed and

$${y}_{i}^{j}$$

may be defined for each ranging technique. In at least one example embodiment, the ranging technique related factors, y, for each ranging technique may be included in a table of factors. For example, each of the values corresponding to the ranging techniques described above may be included in the table of factors. Thus, the ranging technique related factor, γ, may be updated by obtaining a corresponding value for the ranging technique related factor, γ, from the table of factors.

At step S316,

$${y}_{i}^{j}$$

is further updated. In particular, γᵢ^{j} is updated by:

$${y}_{i}^{j} = \frac{{y}_{{i}_{old}}^{j}}{{\sum }_{k = 1}^{{n}_{m}} {y}_{i}^{k}}$$

where

$${y}_{{i}_{old}}^{j}$$

is determined at step S314. In at least one example embodiment, the ranging technique related factor,

$${y}_{i}^{j} ,$$

may be updated based on a normalized value of the ranging technique related factor,

$${y}_{{i}_{old}}^{j} ,$$

determined at step S314. In particular, the ranging technique related factor,

$${y}_{{i}_{old}}^{j} ,$$

determined at step S314 may be divided by a sum of further ranging technique related factors that may each be included in the table of factors.

At step S318, the position of the tag 106 is updated. As described above, the position of the tag 106 may be determined by obtaining min {(f(x)−r)^{T}α(f(x)−r)}. By updating a position of the tag 106, a second estimated location of the object is determined.

At conditional step S320, a position residual of the position of the tag 106 is compared to a third threshold value. In at least one example embodiment, the third threshold value may be defined or predefined for the particular indoor space. In particular, empirical evidence may be used to determine the third threshold value. The third threshold value may be less than the first threshold value. Thus, if the first threshold value is 0.5 m, the third threshold value may be less than 0.5 m.

If the position residual is not less than the third threshold value, then then the position of the tag 106 is further updated at step S318. The step S320 and S318 may be repeated until the position residual is less than the third threshold value.

If the position residual is less than the third threshold value, then the method 300 ends. In at least one example embodiment, when the method 300 ends, the position of the tag 106 may be sufficiently accurate and the position of the tag 106 may be output as a final determined position of the object. In particular, the second estimated location may be output as the position of the object.

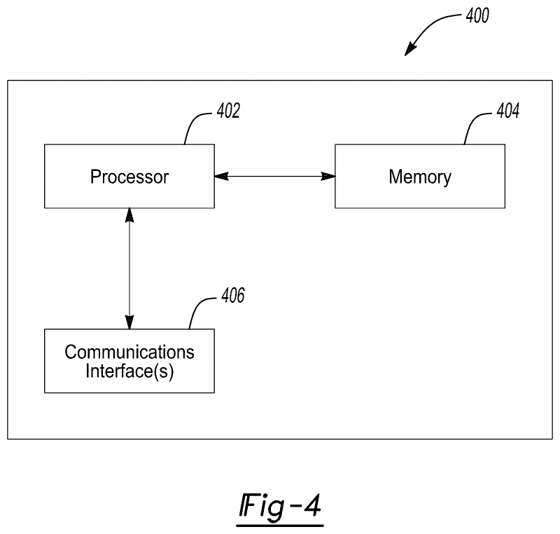

FIG. 4 is a block diagram of a system 400 that may be configured to implement the methods described herein. The system 400 may be a computer or other architecture capable of performing the methods and functionality described herein. The system 400 may include at least one processor 402. The at least one processor 402 may be a central processing unit (CPU) or other suitable processor(s). The system 400 may further include a memory 404 such as a random access memory (RAM), read only memory (ROM), or another suitable memory.

The system 400 also may include one or more input/output devices 406. The one or more input/output devices 406 may include a user input device, such as a keyboard, a keypad, a mouse, and the like, a user output device, such as a display, a speaker, and the like, an input port, an output port, a receiver, a transmitter, one or more storage devices, such as a tape drive, a floppy drive, a hard disk drive, a compact disk drive, and the like, as well as various combinations thereof. The methods and processes described herein may be implemented with elements of the system 400. For example, the processor discussed above with reference to FIG. 3 may be the at least one processor 402 of FIG. 4.

The systems and methods described herein provide improved systems and methods for determining a position of an object in an indoor space. In particular, the position of the object may be accurately determined using multiple ranging measurements and techniques to seamlessly support different positioning accuracies across multiple sub-areas of an indoor space. Further, the position of the object may be determined via communication channels independent from data communications which may minimize traffic congestion and delay in an indoor space. By accurately determining a position of an object in an indoor space, security of an indoor space may be increased. For example, the systems and methods described herein may enable monitoring of secure locations and/or different sub-areas within an indoor space such that an operator or entity is notified when an object enters a secure location or a specific sub-area. Thus, a location of an object with a tag within an indoor space may be monitored to ensure that any security requirements of the indoor space are maintained.

In at least one example embodiment, the systems and methods described herein may be employed in a server room with gated access. For example, each piece of equipment in the server room may be equipped with a tag so that all of the equipment may be positioned accurately within the server room. Thus, when any piece of equipment is moved, whether inside the server room or outside of the server room, the position may be determined by the above-described systems and methods and a user and/or management team may be notified.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for determining a position of an object, the method comprising:
determining a first estimated location of a tag coupled to the object based on a distance matrix, a range matrix, and a weight matrix, the distance matrix including distances between the tag and one or more anchors and the range matrix including ranging measurements for ranging communications between the tag and the one or more anchors;
updating the weight matrix based on distance related factors and ranging technique related factors; and
determining a second estimated location of the tag based on the distance matrix, the range matrix, and the updated weight matrix.

2. The method of claim 1, wherein the ranging measurements for the ranging communications include a ranging measurement for each ranging technique of each anchor based on a distance between the tag and the anchor and a corresponding ranging residual.

3. The method of claim 1, further comprising:
updating the first estimated location before updating the weight matrix if a position residual is greater than a first threshold.

4. The method of claim 1, further comprising:
outputting the second estimated location as the position of the object.

5. The method of claim 4, further comprising:
updating the second estimated location before outputting the second estimated location as the position of the object if a position residual is greater than a second threshold.

6. The method of claim 1, wherein determining the distance related factors includes, for each ranging technique for each anchor of the one or more anchors:
dividing a minimum of a norm of the distance matrix minus the range matrix by an absolute value of a distance between the tag and the anchor minus a ranging measurement for the ranging communications between the tag and the anchor.

7. The method of claim 6, further comprising:
comparing a distance related factor for each anchor and each ranging technique to a distance related factor threshold; and
removing the distance between the tag and the anchor and the ranging measurement for the ranging communications between the tag and the anchor from the distance between the tag and the one or more anchors and the ranging measurements for the ranging communications between the tag and the one or more anchors.

8. The method of claim 1, wherein determining the ranging technique related factors includes, for each ranging technique for each anchor of the one or more anchors:
obtaining a first ranging technique related factor from a table of factors; and
determining a ranging technique related factor as a normalized value based on the first ranging technique related factor and a plurality of further ranging technique related factors in the table of factors.

9. The method of claim 8, wherein determining the ranging technique related factor as a normalized value includes dividing the first ranging technique related factor by a sum of the first ranging technique related factor and the plurality of further ranging technique related factors.

10. The method of claim 1, wherein the weight matrix is a diagonal matrix based on an accuracy requirement for the position of the object and an entry of the weight matrix for an anchor and a ranging technique is determined by multiplying a corresponding distance related factor by a corresponding ranging technique related factor.

11. A system for determining a position of an object, the system comprising:
at least one memory configured to store instructions; and
at least one processor configured to execute the instructions and cause the system to perform
determining a first estimated location of a tag coupled to the object based on a distance matrix, a range matrix, and a weight matrix, the distance matrix including distances between the tag and one or more anchors and the range matrix including ranging measurements for ranging communications between the tag and the one or more anchors,
updating the weight matrix based on distance related factors and ranging technique related factors, and
determining a second estimated location based on the distance matrix, the range matrix, and the updated weight matrix.

12. The system of claim 11, wherein the ranging measurements for the ranging communications include a ranging measurement for each ranging technique of each anchor based on a distance between the tag and the anchor and a corresponding ranging residual.

13. The system of claim 11, wherein at least one processor is further configured to execute the instructions to cause the system to perform:
updating the first estimated location before updating the weight matrix if a position residual is greater than a first threshold.

14. The system of claim 11, wherein at least one processor is further configured to execute the instructions to cause the system to perform:
outputting the second estimated location as the position of the object.

15. The system of claim 14, wherein at least one processor is further configured to execute the instructions to cause the system to perform:
updating the second estimated location before outputting the second estimated location as the position of the object if a position residual is greater than a second threshold.

16. The system of claim 11, wherein determining the distance related factors includes, for each ranging technique for each anchor of the one or more anchors:
dividing a minimum of a norm of the distance matrix minus the range matrix by an absolute value of a distance between the tag and the anchor minus a ranging measurement for the ranging communications between the tag and the anchor.

17. The system of claim 16, wherein at least one processor is further configured to execute the instructions to cause the system to perform:
comparing a distance related factor for each anchor and each ranging technique to a distance related factor threshold; and
removing the distance between the tag and the anchor and the ranging measurement for the ranging communications between the tag and the anchor from the distance between the tag and the one or more anchors and the ranging measurements for the ranging communications between the tag and the one or more anchors.

18. The system of claim 11, wherein determining the ranging technique related factors includes, for each ranging technique for each anchor of the one or more anchors:
obtaining a first ranging technique related factor from a table of factors; and
determining a ranging technique related factor as a normalized value based on the first ranging technique related factor and a plurality of further ranging technique related factors in the table of factors.

19. The system of claim 18, wherein determining the ranging technique related factor as a normalized value includes dividing the first ranging technique related factor by a sum of the first ranging technique related factor and the plurality of further ranging technique related factors.

20. The system of claim 11, wherein the weight matrix is a diagonal matrix based on an accuracy requirement for the position of the object and an entry of the weight matrix for an anchor and a ranging technique is determined by multiplying a corresponding distance related factor by a corresponding ranging technique related factor.
